(19) United States
(12) Patent Application Publication
(10) Pub. No.: US 2018/0344576 A1
(43) Pub. Date: Dec. 6, 2018

(54) INTERACTIVE BABY BOTTLE WITH DEPRESSIBLE CONTROLS, INTEGRATED MEMORY, AND ELECTROACOUSTIC TRANSDUCER

(71) Applicant: Janet Somsen, North Ogden, UT (US)

(72) Inventor: Janet Somsen, North Ogden, UT (US)

(21) Appl. No.: 15/613,157

(22) Filed: Jun. 3, 2017

(51) Int. Cl. A61J 9/06; A61J 9/08; A63H 5/00

(52) U.S. Cl. CPC A61J 9/0653; A63H 5/00; A61J 9/0623; A61J 9/085

(57) ABSTRACT

A substantially cylindrical interactive baby bottle comprising a base unit having a music-playing digital mechanism, persistent computer-readable memory, and depressible switches adapted to playback prerecorded media while an infant is nursing from the bottle.

### FIELD OF THE INVENTION

This invention relates to a baby bottles and more specifically relates to a baby bottle with music playing means.

### BACKGROUND

### Description of the Related Art

From time to time infants being transitioned from nursing to bottles resist taking or drinking milk or formula from conventional baby bottles. Baby bottles have been well-known in the art for decades. Baby bottles are used for the artificial nursing of infant children in various forms, shapes, and configurations. Since infant children are resist feeding from a bottle, parents frequently look to attempt to calm them, distract them, or entertain them during nursing.

On occasions, milk is accepted by a baby without protest or when the baby is extremely hungry. Various methods have been employed by parents to induce a baby to nurse from a bottle, including attempting to calm or soothe the baby with words, singing, television, or other calming influences. As shall be fully described herein this invention is aimed at integrating a digital music playing device with a bottle, sippy cup, or other common baby implement for the purposes of calming and entertaining a baby during nursing from the bottle or implement.

It is an object of the present invention to provide a baby bottle with a digital music-playing base unit actuated in some embodiments by the movement of the base unit. Prerecorded digital media including music on insertable computer-readable memory is played back during nursing. No bottle known to date provides a portable integrated, digital music system which for soothing, distracting and entertaining a child. These and other objects and advantages of the present invention are desirable in the art.

### SUMMARY

From the foregoing discussion, it should be apparent that a need exists for an interactive baby bottle with depressible controls, integrated memory and an electroacoustic transducer. Beneficially, such a bottle would include an anti-colic check valve and digital motion-activated controls.

The present invention has been developed in response to the present state of the art, and in particular, in response to the problems and needs in the art that have not yet been fully solved by currently available baby bottles and/or toddler nursing and feeding apparati. Accordingly, the present invention has been developed to provide an interactive baby bottle adapted to playback prerecorded digital media, the baby bottle comprising: a substantially cylindrical main body have an exteriorly-threaded open top end and exteriorly-threaded open bottom end; a substantially cylindrical concave base unit defining an interiorly-threaded open top end for engaging and mating with corresponding threading on the open bottom end of the main body, the base unit comprising: a microchip, a slot for receiving detachably persistent computer-readable memory having prerecorded media, one or more electroacoustic transducer for emanating sound, an anti-colic check valve, a power supply, and a plurality of switches for activating digital features of the base unit; and a cap having an open top end and open bottom end, the cap defining a hollow recess through a longitudinal axis.

The baby bottle may further comprise a plurality of depressible switches for raising and lower a volume of sound emanating from the electroacoustic transducers.

The baby bottle may further comprise an amplifier and a control module comprising the microchip, the control module configured to manipulable using the switches to start, stop, fast forward and rewind playback of an audio file in computer readable memory. The baby bottle may further comprise a wireless transceiver adapted to receive wireless input via the wireless transceiver transmitted from a tablet computer, the wireless input changing playback settings on the bottle.

Alternatively, the baby bottle further comprises a motion-sensing mechanism for activating digital playback in response to motion of the baby bottle.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention may be practiced without one or more of the specific features or advantages of a particular embodiment. In other instances, additional features and advantages may be recognized in certain embodiments that may not be present in all embodiments of the invention.

These features and advantages of the present invention will become more fully apparent from the following description and appended claims, or may be learned by the practice of the invention as set forth hereinafter.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1A is a side perspective view illustrating one embodiment of an interactive baby bottle in accordance with the present invention;

FIG. 1B is a sectioned side perspective view illustrating one embodiment of an interactive baby bottle in accordance with the present invention;

FIG. 1C is a sectioned side perspective view illustrating one embodiment of an interactive baby bottle in accordance with the present invention;

FIG. 1D is a top-side perspective view illustrating one embodiment of an interactive baby bottle in accordance with the present invention;

FIG. 2A is a top side perspective view of a disassembled base unit of an interactive baby bottle in accordance with the present invention;

FIG. 2B is a top side perspective view of an assembled base unit of an interactive baby bottle in accordance with the present invention;

FIG. 3 is a top side perspective view of a disassembled interactive baby bottle in accordance with the present invention;

FIG. 4 is a sectioned side perspective view illustrating another embodiment of an interactive baby bottle in accordance with the present invention;

FIG. 5 is a side perspective view illustrating another embodiment of an interactive baby bottle in accordance with the present invention;

FIG. 6 is a top side perspective view of a disassembled interactive baby bottle in accordance with the present invention; and

FIG. 7 is a top perspective view of an interactive baby bottle in accordance with the present invention.

### DETAILED DESCRIPTION

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

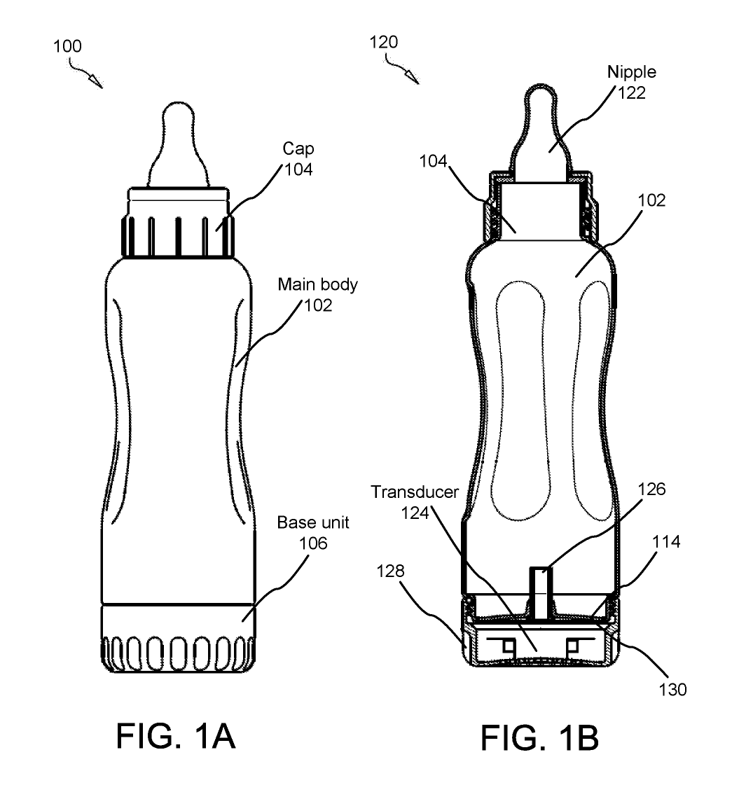

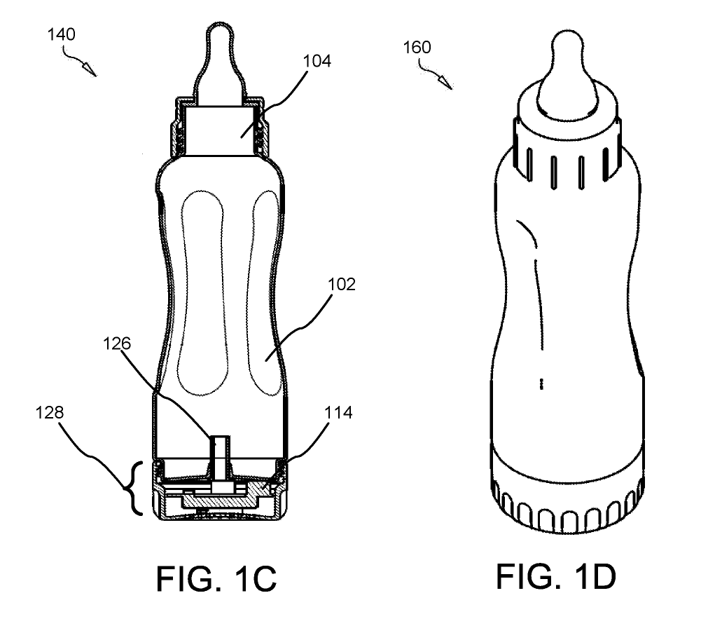

FIG. 1A is a side perspective view illustrating one embodiment of an interactive baby bottle 100 in accordance with the present invention. The interactive baby bottle 100 comprises a main body 102, a cap 104, and a base unit 106.

It is an object of the present invention to provide a digitally-activated music-playing baby bottle 100 which is capable of being loaded with prerecorded content. The baby bottle 100, as commonly known, may be adapted to store and dispense any number of a plurality of perishable liquids including milk, formula, water, juice, and the like. The baby bottle 100 may be fabricated of an electrically non-conductive polymeric material and may comprise a main body 102, or housing, formed in the shape of a conventional sippy cup, baby bottle, or other commonly known container shape. Typically, the main body 102 is substantially cylindrical.

A detachable cylindrical base unit 106 is threadably-connected to the main body 102 in the shown embodiment. In other embodiments, the base unit 106 and main body 102 are formed as a single integrated piece. The body 102 in the shown embodiment is exteriorly-threaded to mate with an interiorly-threaded base unit 106.

The bottle 100 comprises a cap 104. The cap 104 may comprise a hollow cylindrical member which affixed over a nipple to the main body 102 and holds the nipple in place using a cantilievered annual ring circumscribing the recess formed by an open top end as known to those of skill in the art.

A motion activated switch 130 within the base unit 106 may conduct electricity from the positive terminal of an internal power-supply to the music-playing mechanism thereby completing the circuit when motion of the bottle 100 is detected. In other embodiments, the digital base unit is activated manually with a depressible switch.

The bottle 100 also comprises an anti-colic check valve 126 as shown.

FIG. 1B is a sectioned side perspective view illustrating one embodiment of an interactive baby bottle 200 in accordance with the present invention.

The bottle 200 may comprise an anti-colic check value.

In various embodiments, the base unit 106 comprises an outer shell 128 or housing cylindrically-shaped with a closed bottom end and an open top end for mating with the main body 102. The base unit 106 comprises an electroacoustic transducer 124, or speaker, for emanating sound from the bottom of the base unit 106. The base unit 106 may comprise a microchip 114 adapted to play prerecorded music stored in memory in logical connectivity with the microchip.

The speaker, or electroacoustic transducer 124, may comprise a flat speaker fixed in positioned generally adjacent a closed bottom surface of base unit 106.

A motion activated switch 130 within the base unit 106 may conduct electricity from the positive terminal of an internal power-supply to the music-playing mechanism thereby completing the circuit when motion of the bottle 100 is detected. In other embodiments, the digital base unit is activated manually with a depressible switch.

FIG. 1C is a sectioned side perspective view illustrating one embodiment of an interactive baby bottle 140 in accordance with the present invention.

As shown.

FIG. 1D is a top-side perspective view illustrating one embodiment of an interactive baby bottle in accordance with the present invention;

As shown.

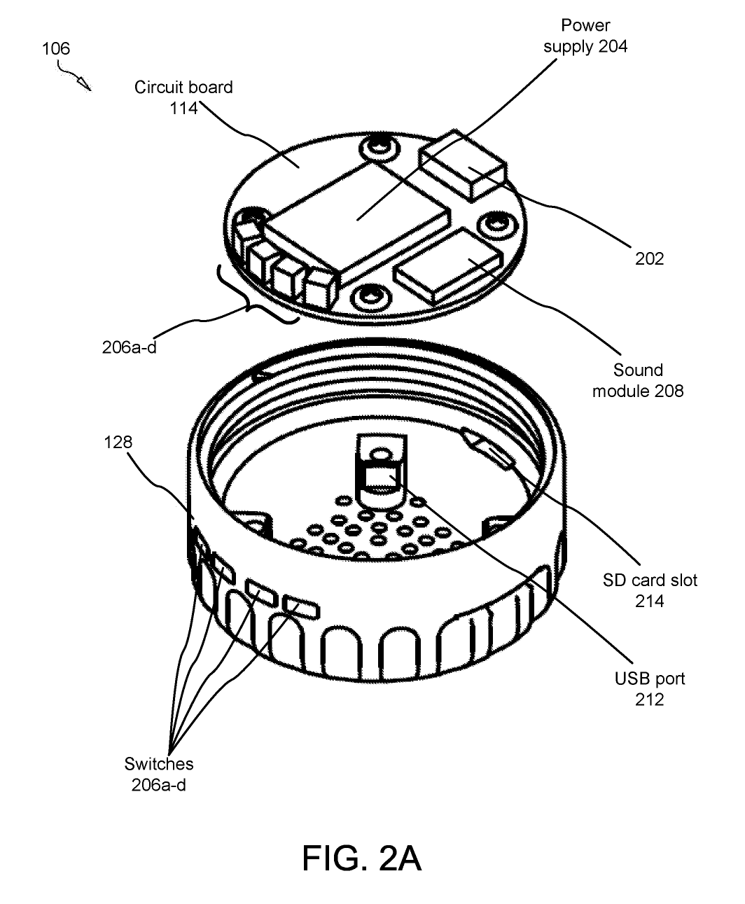

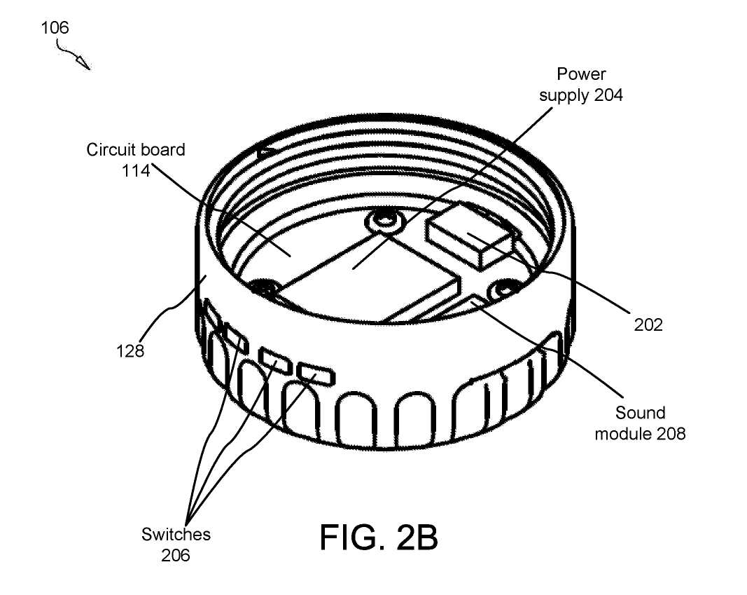

FIG. 2A is a top side perspective view of a base unit of an interactive baby bottle 200 in accordance with the present invention. The base unit 106 comprises a concave cylindrical shell 128 threaded interiorly. The base unit 106 comprises a memory slot 202 for receiving an SD card or memory with prerecorded music, a power supply 204, and a circuit board 114. The base unit 106 defines a plurality of apertures through which depressible switches 206 traverse. These depressible switches 206a-d are operable to power the base unit 106 on, to advance music playing from the base unit 106 to a subsequent or previous track, to stop or pause playback, and to increase or decrease volume.

The concave base unit 106 may be formed from polymeric, metallic, or metal alloys. The base unit 106 may define a hollow interior recess for receiving and housing a number of components, including a speaker, a middle balance ring, an aluminum ear cup, an ear cup plastic liner, and an ear cup plastic cover.

The power supply 204 may comprise a battery as commonly known to those of skill in the art. The power supply 204 is fastened by wire to the sound module 208 and/or and the switches 206 or connected via the circuit board 114.

The bottle 200 comprises persistent computer-readable memory. The memory may comprise a memory card, and is well-known to those of skill in the art. The memory may be insertable and removable from a positioning slot defined by base unit 106. In various embodiments, the audio recordings are stored in the memory for playback. The audio recordings may be in MP3, WAV, or other formats known to those of skill in the art.

The depressible switches 206a-d may comprise volume controls which are adapted to raise or lower volume of sound emitting or emanating from speakers or electroacoustic transducers 124. In various embodiments, the depressible buttons 112 raise or lower resistance to electrical current flowing to the speakers.

In the shown embodiments, switch 206a comprises an on/off switch which, when depressed for three seconds, will begin to play. The switch 206b pauses playback and resumes playback. Switch 206c lowers volume while switch 206d raises volume.

In various embodiments, the base unit 106 comprises a sound module 208 configured to playback audio and manipulate playback in response to depression of various depressible switches 206 being activated. The sound module comprises 208 comprises all of the logic necessary to read prerecorded media and enable playback through one or more speakers.

Removal persistent computer-readable storage may be inserted through the SD card slot 214 in the housing 128 and into the memory slot 202. The memory slot 202 is in logical connectivity with a microchip and may comprise a microchip.

The base unit 106 also comprises a USB port 212 for receiving a USB cable and charging the power supply 204 of the base unit 106. The USB cable inserts through the USB Port 212 defined by the housing 128.

The base unit 106 comprises a sound module 210

FIG. 2B is a top side perspective view of an assembled base unit 106 of an interactive baby bottle in accordance with the present invention. The base unit comprises a housing 128, a circuit board 114, a power supply 204, a USB slot 202, a sound module 208, and switches 206. Each are substantially described above and below. As shown, the circuit board is disposed at the base of a recess defines by the concave housing 128.

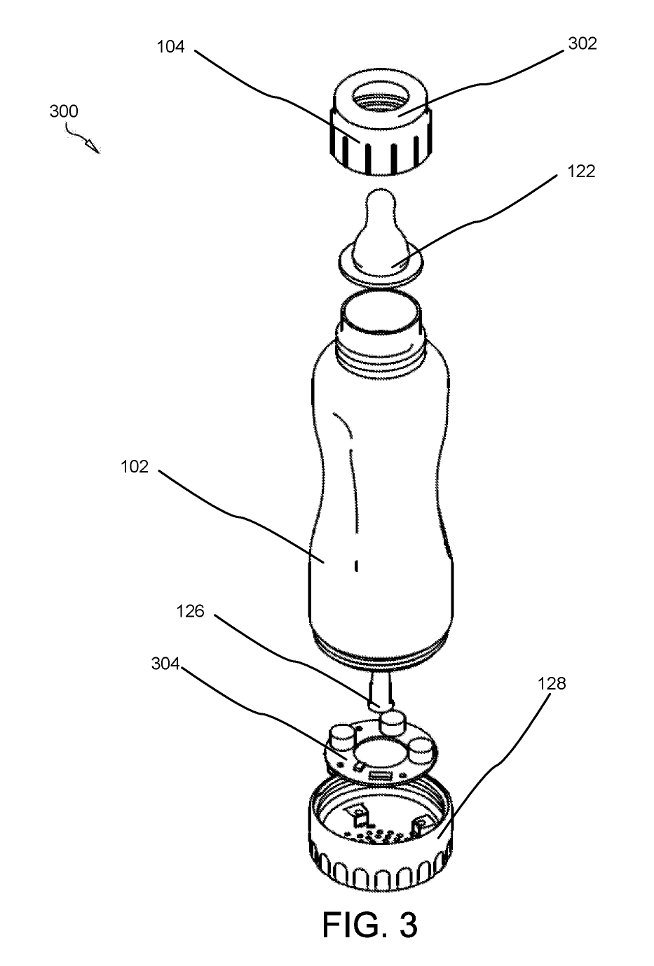

FIG. 3 is a top side perspective view of a disassembled interactive baby bottle 300 in accordance with the present invention.

The bottle 300 may comprise means for relaying and receiving electrical signals enabling device-to-device communication (meaning wireless transmission of media between). The bottle 300 may be configured to make use of the Bluetooth® protocols and procedures enabling device-to-device intercommunication connectivity. This functionality may be provided by incorporating the Bluetooth Intercom Profile® and/or the Bluetooth Telephony Profile®, or other wireless technologies known to those of skill in the art.

The anti-colic check valve 126 is shown.

The bottle 300 comprises an uninterrupted cantilevered annular ring interiorly-circumscribing the open top end of the cap 104.

The device 300 may comprise a battery-operated sound module 304 with preloaded music in firmware as shown, but preferably comprises the sound module 208.

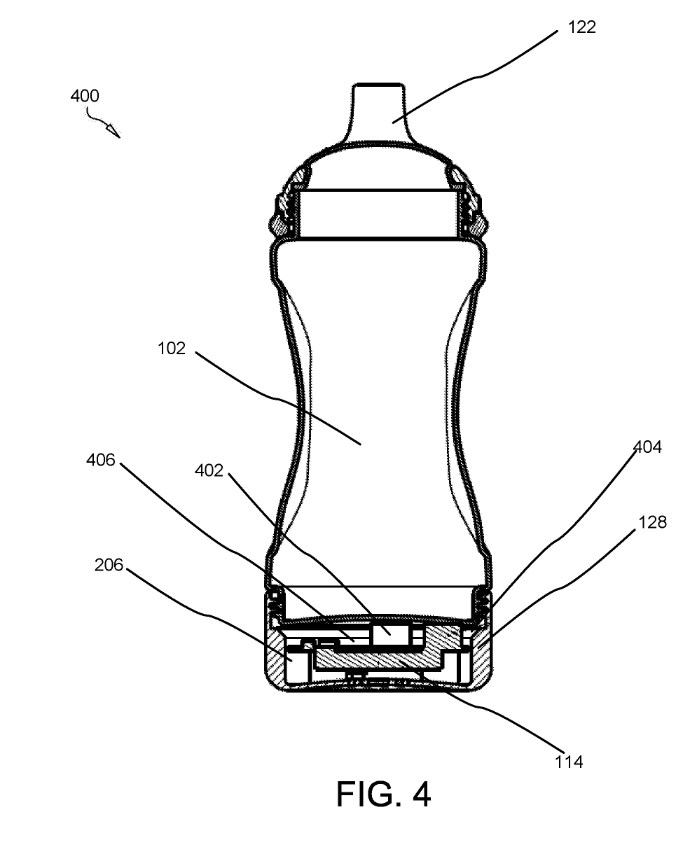

FIG. 4 is a sectioned side perspective view illustrating another embodiment of an interactive baby bottle 400 in accordance with the present invention.

The baby bottle 400 of the present invention distracts, calms and entertains a baby during nursing. The baby bottle 400 comprises a wireless transceiver 402 for networking the baby bottle wirelessly with a separate data processing device (DPD) as known to those of skill in the art and described herein.

The device 400 may also comprise an amplifier 404 as known to those of skill in the art as well as a motion sensor 406 for detecting motion of the device 400 and activating the sound module 208 in response thereto.

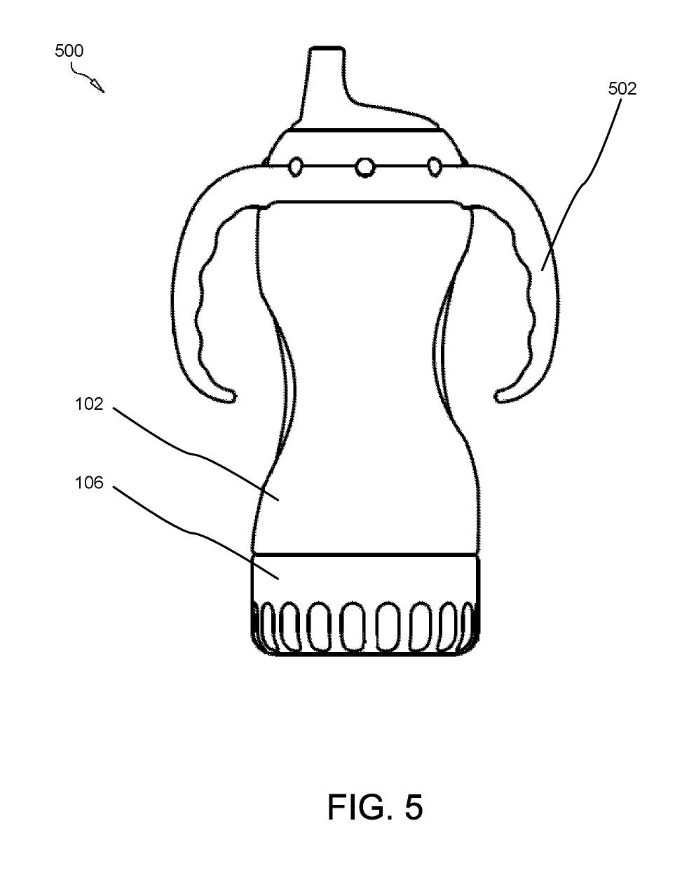

FIG. 5 is a side perspective view illustrating another embodiment of an interactive baby bottle 500 in accordance with the present invention.

The bottle 500 comprises one or more handles 502 for use by a baby feeding with the bottle 500.

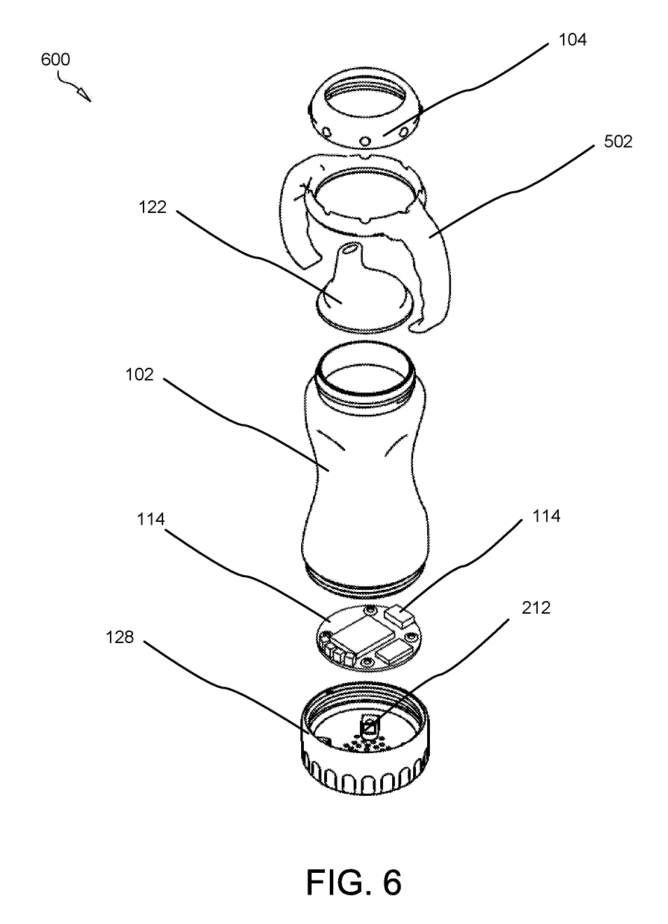

FIG. 6 is a top side perspective view of a disassembled interactive baby bottle in accordance with the present invention.

The handles 502 are disposed beneath cap 104.

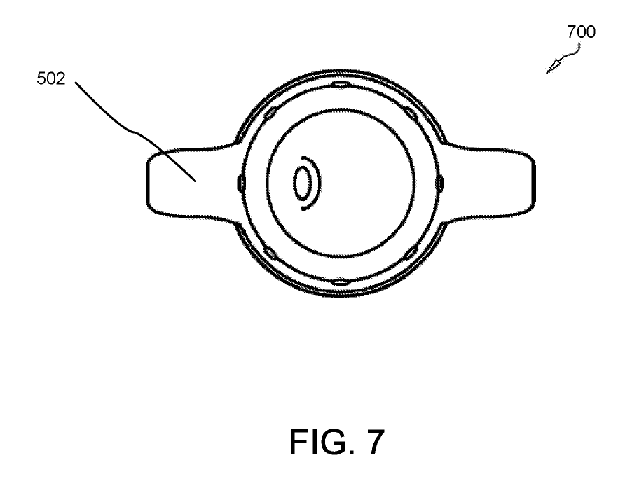

FIG. 7 is a top perspective view of an interactive baby bottle in accordance with the present invention.

As shown.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. An interactive baby bottle adapted to playback prerecorded digital media to calm and entertain a baby, the baby bottle comprising:
a substantially cylindrical main body have an exteriorly-threaded open top end and exteriorly-threaded open bottom end;
a substantially cylindrical concave base unit defining an interiorly-threaded open top end for engaging and mating with corresponding threading on the open bottom end of the main body and defining a plurality of apertures through which switches traverse, the base unit comprising:
a circuit board,
a memory slot for receiving detachably persistent computer-readable memory having prerecorded media,
one or more electroacoustic transducers for emanating sound,
an anti-colic check valve,
a power supply,
an amplifier,
a USB slot,
a motion-activated switch adapted to activate a music-playing mechanism, and
a plurality of depressible switches for activating digital features of the base unit including: an on/off switch, two volume switches adapted to adjust volume of playback media, a play switch adapted to commence media playback,
computer-readable memory; and
a cap having an open top end and open bottom end, the cap defining a hollow recess through a longitudinal axis;
an uninterrupted cantilevered annular ring interiorly-circumscribing the open top end of the cap;
a wireless transceiver adapted to receive wireless input via the wireless transceiver transmitted from a DPD, the wireless input changing playback settings on the baby bottle.

2. The baby bottle of claim 1, further comprising a plurality of depressible switches for raising and lower a volume of sound emanating from the electroacoustic transducers.

3. The baby bottle of claim 2, further comprising an amplifier and a control module comprising a microchip, the control module configured to manipulate playback using the switches to start, stop, fast forward and rewind functions.

4. (canceled)

5. The baby bottle of claim 1, further comprising a motion-sensor for activating digital playback in response to motion of the baby bottle.

6. (canceled)

7. (canceled)

8. (canceled)
